(19) United States
(12) Patent Application Publication
(10) Pub. No.: US 2024/0372267 A1
(43) Pub. Date: Nov. 7, 2024

(54) MULTI-SECTOR ANTENNA HAVING EFFICIENT MULTI-MODE OPERATION AND METHODS OF OPERATING SAME

(71) Applicant: Outdoor Wireless Networks LLC, Claremont, NC (US)

(72) Inventors: Zhanming Zhang, Suzhou (CN); Ligang Wu, Suzhou (CN); XiaoHua Hou, Richardson, TX (US); Fusheng Lv, Suzhou (CN); Fan He, Suzhou (CN)

(21) Appl. No.: 18/652,059

(22) Filed: May 1, 2024

(30) Foreign Application Priority Data
May 4, 2023 (CN) 202310491839.9

(51) Int. Cl. H01Q 21/00; H01P 1/18; H01P 3/00; H01P 5/22

(52) U.S. Cl. CPC H01Q 21/0006; H01P 1/18; H01P 5/22; H01P 3/003

(57) ABSTRACT

A multi-mode antenna includes a feed network including a cascaded arrangement of a first phase shifter and hybrid coupler pair, which is responsive to a radio frequency (RF) input feed signal, and a second phase shifter and hybrid coupler pair, which is responsive to an RF feed signal generated at a second output port of the first phase shifter and hybrid coupler pair. First, second and third arrays of radiating elements are provided. The first array is responsive to a RF feed signal derived from a first output port of the first phase shifter and hybrid coupler pair; the second array is responsive to an RF feed signal derived from a first output port of the second phase shifter and hybrid coupler pair; and the third array is responsive to an RF feed signal derived from a second output port of the second phase shifter and hybrid coupler pair.

### FIELD OF THE INVENTION

The present invention relates to radio communications and, more particularly, to multi-sector antennas used in cellular communication systems.

### BACKGROUND

A 3-sector antenna is a type of antenna system commonly used in cellular networks; it is typically designed to divide a coverage area into three 120° sectors or zones, and is configured to generate a directional beam that provides coverage to each of the three sectors. As shown by FIGS. 1A-1B, a 3-sector antenna 10 typically uses multiple arrays of radiating elements 12a, 12b, 12c (i.e., multiple “antenna arrays”) to create corresponding beams 14a, 14b, 14c that provide coverage to each of the corresponding sectors. As will be understood by those skilled in the art, the work state of these antenna arrays 12a, 12b, 12c may be controlled using relatively complex remote radio unit (RRU) technology.

### SUMMARY OF THE INVENTION

A multi-mode antenna according to embodiments of the invention includes a feed network and a plurality of antenna arrays (“arrays”) responsive to feed signals generated by the feed network. In some of these embodiments, the feed network can include a cascaded arrangement of a first phase shifter and hybrid coupler pair, which is responsive to a radio frequency (RF) input feed signal, and a second phase shifter and hybrid coupler pair, which is responsive to an RF feed signal generated at a second output port of the first phase shifter and hybrid coupler pair. In addition, the plurality of arrays may include: (i) a first array (ARRAY1) responsive to a RF feed signal derived from a first output port of the first phase shifter and hybrid coupler pair, (ii) a second array (ARRAY2) responsive to an RF feed signal derived from a first output port of the second phase shifter and hybrid coupler pair, and (iii) a third array (ARRAY3) responsive to an RF feed signal derived from a second output port of the second phase shifter and hybrid coupler pair. In some of these implementations, the hybrid couplers may be selected from a group consisting of parallel λ/2 open branch couplers, multi-segment hybrid couplers, and coplanar waveguide (CPW) circle hybrid couplers, etc. Higher and wider band performance may also be achieved using hybrid couplers formed from electronic chips.

According to an additional embodiment of the invention, the feed network may further include a third phase shifter and hybrid coupler pair, which is responsive to an RF feed signal generated at the first output port of the first phase shifter and hybrid coupler pair. In this embodiment, the first array may be responsive to an RF feed signal derived from a first output port of the third phase shifter and hybrid coupler pair; and a fourth antenna array may be provided, which is responsive to an RF feed signal derived from a second output port of the third phase shifter and hybrid coupler pair.

According to further embodiments of the invention, the first, second and third arrays may be configured to radiate in respective first, second and third sectors of a three-sector antenna, and the feed network may be configured such that the first array is responsive to an RF signal that bypasses the second phase shifter and hybrid coupler pair, whereas the second and third arrays are responsive to RF signals that pass through a cascaded arrangement of the first phase shifter and hybrid coupler pair and the second phase shifter and hybrid coupler pair. In some of these embodiments, the feed network is configured to support, through adjustments to the first and second phase shifters, each of the following seven operating modes: (i) ARRAY1, ARRAY2 and ARRAY3 active, (ii) ARRAY1 and ARRAY2 active, ARRAY3 inactive (iii) ARRAY1 and ARRAY3 active, ARRAY2 inactive (iv) ARRAY2 and ARRAY3 active, ARRAY1 inactive, (v) ARRAY1 active, ARRAY2 and ARRAY3 inactive, (vi) ARRAY2 active, ARRAY1 and ARRAY3 inactive, and (vii) ARRAY3 active, ARRAY1 and ARRAY2 inactive. In addition, relatively fine “analog” adjustments to the first and second phase shifters may enable the feed network to support a plurality of operating modes that are intermediate the seven operating modes, such that one or more of the multiple arrays is only partially active or partially inactive.

According to still further embodiments of the invention, a multi-mode antenna may include first, second and third antenna arrays (ARRAY1, ARRAY2 and ARRAY3) responsive to first, second and third RF feed signals, respectively, and an enhanced feed network. This feed network is configured to generate the first, second and third RF feed signals in response to a radio frequency (RF) input feed signal, and support, through adjustments therein, each of the following seven operating modes: (i) ARRAY1, ARRAY2 and ARRAY3 active, (ii) ARRAY1 and ARRAY2 active, ARRAY3 inactive (iii) ARRAY1 and ARRAY3 active, ARRAY2 inactive (iv) ARRAY2 and ARRAY3 active, ARRAY1 inactive, (v) ARRAY1 active, ARRAY2 and ARRAY3 inactive, (vi) ARRAY2 active, ARRAY1 and ARRAY3 inactive, and (vii) ARRAY3 active, ARRAY1 and ARRAY2 inactive, and a plurality of modes intermediate these seven operating modes. In some of these embodiments, the feed network is configured to include a plurality of phase shifters therein, and each of the seven operating modes is established by a unique setting of these phase shifters. In further embodiments, each of the plurality of phase shifters (e.g., wiper-type, slider-type) is paired with a corresponding coupler within the feed network.

According to additional embodiments of the invention, a method of operating a multi-sector antenna is provided that includes adjusting at least one phase shifter within a cascaded arrangement of a first phase shifter and hybrid coupler pair having an input port configured to receive a radio frequency (RF) input feed signal, and a second phase shifter and hybrid coupler pair having an input port responsive to a RF feed signal generated at a second output port of the first phase shifter and hybrid coupler pair, to thereby switch the multi-sector antenna between at least two of the following seven operating modes: (i) ARRAY1, ARRAY2 and ARRAY3 active, (ii) ARRAY1 and ARRAY2 active, ARRAY3 inactive (iii) ARRAY1 and ARRAY3 active, ARRAY2 inactive (iv) ARRAY2 and ARRAY3 active, ARRAY1 inactive, (v) ARRAY1 active, ARRAY2 and ARRAY3 inactive, (vi) ARRAY2 active, ARRAY1 and ARRAY3 inactive, and (vii) ARRAY3 active, ARRAY1 and ARRAY2 inactive, where ARRAY1, ARRAY2 and ARRAY3 correspond to first, second and third antenna arrays within the multi-sector antenna. In some of these embodiments, the first array (ARRAY1) is responsive to a RF feed signal derived from a first output port of the first phase shifter and hybrid coupler pair, the second array (ARRAY2) is responsive to an RF feed signal derived from a first output port of the second phase shifter and hybrid coupler pair, and the third array (ARRAY3) is responsive to an RF feed signal derived from a second output port of the second phase shifter and hybrid coupler pair. The adjusting operation may also include adjusting at least one phase shifter within the cascaded arrangement to thereby switch the multi-sector antenna into an operating mode that is intermediate at least two of the seven operating modes.

### BRIEF DESCRIPTION OF THE DRAWINGS

FIG. 1A is a schematic diagram of a 3-sector (120°/sector) antenna having a work state that may be controlled by a remote radio unit (RRU), according to the prior art.

FIG. 1B is a perspective view of a 3-sector antenna according to the prior art.

FIG. 2A is a multi-mode 3-sector antenna having a feed network according to an embodiment of the invention.

FIG. 2B is a multi-mode 4-sector antenna having a feed network according to an embodiment of the invention.

FIG. 3A is a phase shifter and hybrid coupler pair set to a first power ratio, which may be used in the feed networks of FIGS. 2A-2B.

FIG. 3B is a phase shifter and hybrid coupler pair set to a second power ratio, which may be used in the feed networks of FIGS. 2A-2B.

FIG. 3C is a phase shifter and hybrid coupler pair set to a third power ratio, which may be used in the feed networks of FIGS. 2A-2B.

FIG. 3D is a phase shifter and hybrid coupler pair set to a fourth power ratio, which may be used in the feed networks of FIGS. 2A-2B.

FIG. 3E is a phase shifter and hybrid coupler pair set to a fifth power ratio, which may be used in the feed networks of FIGS. 2A-2B.

FIG. 4A illustrates the 3-sector antenna of FIG. 2A set to a first mode of operation by the feed network.

FIG. 4B illustrates the 3-sector antenna of FIG. 2A set to a second mode of operation by the feed network.

FIG. 4C illustrates the 3-sector antenna of FIG. 2A set to a third mode of operation by the feed network.

FIG. 4D illustrates the 3-sector antenna of FIG. 2A set to a fourth mode of operation by the feed network.

FIG. 4E illustrates the 3-sector antenna of FIG. 2A set to a fifth mode of operation by the feed network.

FIG. 4F illustrates the 3-sector antenna of FIG. 2A set to a sixth mode of operation by the feed network.

FIG. 4G illustrates the 3-sector antenna of FIG. 2A set to a seventh mode of operation by the feed network.

FIGS. 5A-5C illustrate a parallel N/2 open branch hybrid coupler, a multi-segment hybrid coupler, and a coplanar waveguide (CPW) circle hybrid coupler, respectively, which may be used in the feed networks of FIGS. 4A-4G.

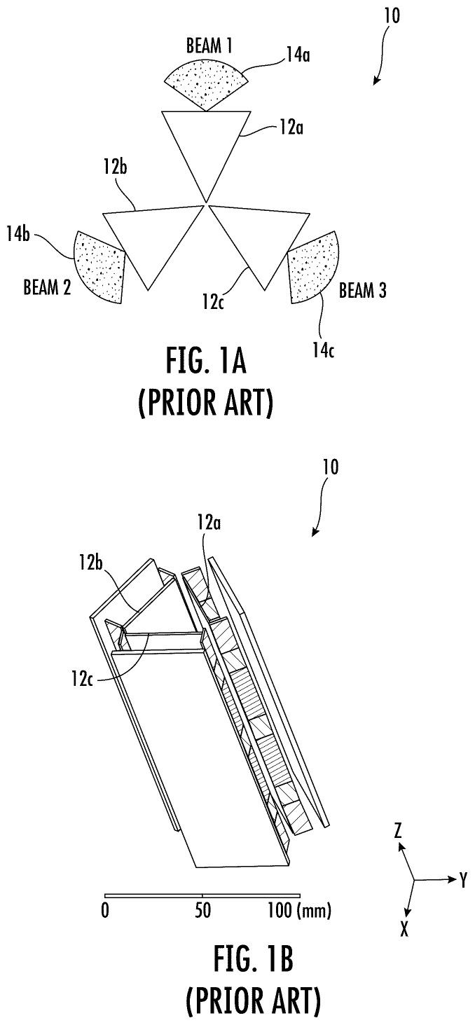

### DETAILED DESCRIPTION OF EMBODIMENTS

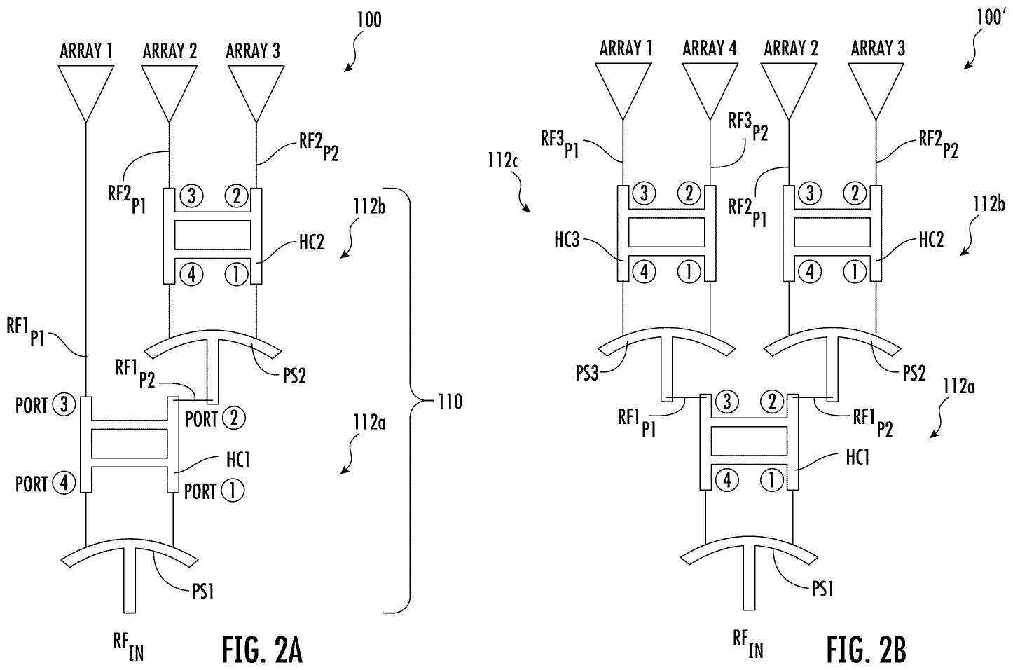

Referring now to FIG. 2A, a multi-mode 3-sector antenna 100 according to an embodiment of the invention is illustrated as including first, second and third antenna arrays (ARRAY1, ARRAY2, ARRAY3) that receive corresponding RF feed signals from a feed network 110. As described hereinbelow, the feed network 110, which may be configured to support relatively low power and low cost “small cell” antenna applications in some embodiments, includes a cascaded arrangement of a first phase shifter and hybrid coupler pair 112a, which is responsive to a radio frequency (RF) input feed signal RF_{IN}, and a second phase shifter and hybrid coupler pair 112b, which is responsive to an RF feed signal RF1_{P2} generated at a second output port of the first phase shifter and hybrid coupler pair 112a. This first phase shifter and hybrid coupler pair 112a is shown as including: (i) a first wiper-type phase shifter PS1 having an input port configured to receive the input feed signal RF_{IN}, and (ii) a first hybrid coupler HC1 having first and second “input” ports (ports 4, 1) electrically connected to a pair of output ports of the first wiper-type phase shifter PS1. Similarly, the second phase shifter and hybrid coupler pair 112b is shown as including: (i) a second wiper-type phase shifter PS2 having an input port configured to receive the feed signal RF1_{P2} generated at the second output port of the first phase shifter and hybrid coupler pair 112a, which corresponds to a second output port (port 2) of the first hybrid coupler HC1, and (ii) a second hybrid coupler HC2 having first and second “input” ports (ports 4, 1) electrically connected to a pair of output ports of the second wiper-type phase shifter PS2.

Furthermore, the first array (ARRAY1) is responsive to a RF feed signal RF1_{P1} derived from a first output port of the first phase shifter and hybrid coupler pair 112a, which corresponds to a first output port (port 3) of the first hybrid coupler HC1, whereas the second array (ARRAY2) is responsive to an RF feed signal RF2_{P1} derived from a first output port of the second phase shifter and hybrid coupler pair 112b, which corresponds to a first output port (port 3) of the second hybrid coupler HC2. In addition, the third array (ARRAY3) is responsive to an RF feed signal RF2_{P2} derived from a second output port of the second phase shifter and hybrid coupler pair 112b, which corresponds to a second output port (port 2) of the second hybrid coupler HC2. As used herein, a signal “derived” from a port of a device includes: (i) a signal generated directly at the port, or (ii) a signal that passes through one or more active and/or passive elements electrically coupled to the port.

Next, as shown by FIG. 2B, the multi-mode antenna 100 of FIG. 2A may be modified by adding a fourth antenna array (ARRAY4) to thereby provide a 4-sector antenna 100′ that can support as many as fourteen (14) modes of operation. In this embodiment, a third phase shifter and hybrid coupler pair 112c may be added to the feed network to thereby drive the first and fourth arrays (ARRAY1, ARRAY4), in response to an RF feed signal RF1_{P1} signal generated at the first output port of the first phase shifter and hybrid coupler pair 112a. This third phase shifter and hybrid coupler pair 112c is shown as including: (i) a third wiper-type phase shifter PS3 having an input port configured to receive the feed signal RF1_{P1}, and (ii) a third hybrid coupler HC3 having first and second “input” ports (ports 4, 1) electrically connected to a pair of output ports of the third wiper-type phase shifter PS3. Moreover, the first array (ARRAY1) is responsive to an RF feed signal RF3_{P1} derived from a first output port of the third phase shifter and hybrid coupler pair 112c, which corresponds to a first output port (port 3) of the third hybrid coupler HC3, whereas the fourth array (ARRAY4) is responsive to an RF feed signal RF3_{P2} derived from a second output port of the third phase shifter and hybrid coupler pair 112c, which corresponds to a second output port (port 2) of the third hybrid coupler HC3.

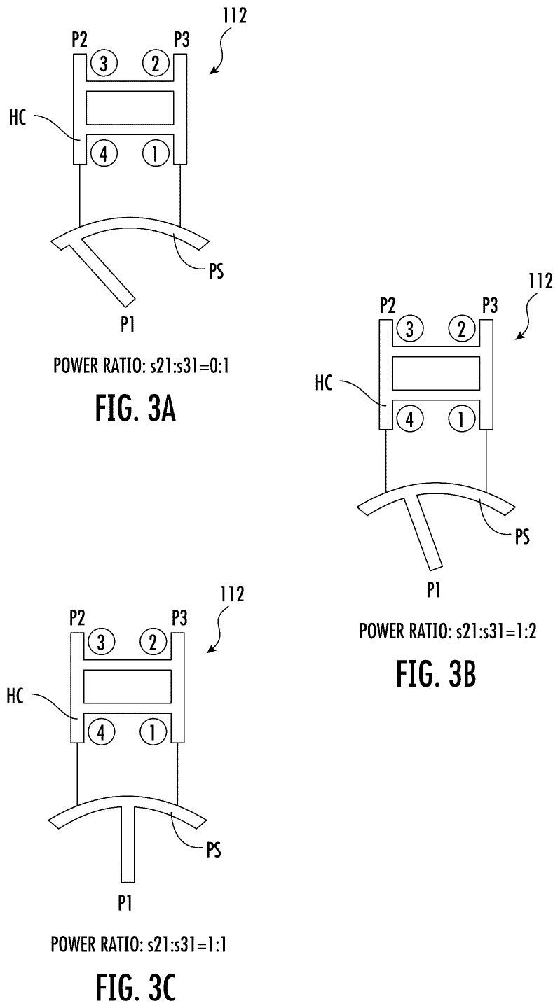

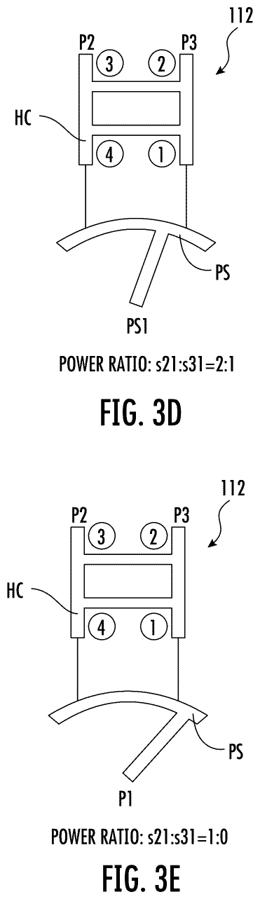

The multi-mode operation of each phase shifter and hybrid couple pair within the embodiments of FIGS. 2A-2B will now be described with reference to FIGS. 3A-3E, which illustrate five (5) discrete power transfer configurations associated with a single phase shifter and hybrid coupler pair 112 having three ports. These three ports P1, P2, P3 correspond to an input port, a first output port and a second output port, respectively. Now, in FIG. 3A, a first power ratio of 0:1 between the first output port P2 and the second output port P3 can be achieved by adjusting a wiper within the wiper-type phase shifter PS to a first position (e.g., −45°), as shown, such that essentially all of the power associated with an RF feed signal received at the input port P1 is transferred to the second output port P3. And, in FIG. 3B, a second power ratio of 1:2 between the first output port P2 and the second output port P3 can be achieved by adjusting the wiper within the wiper-type phase shifter PS to a second position (e.g., −9.5°), as shown, such that about 33% of the power associated with an RF feed signal received at the input port P1 is transferred to the first output port P2, and about 66% of the power is transferred to the second output port P3. Next, in FIG. 3C, a third power ratio of 1:1 between the first output port P2 and the second output port P3 can be achieved by adjusting the wiper within the wiper-type phase shifter PS to a third position (e.g., 0°), as shown, such that about 50% of the power associated with an RF feed signal received at the input port P1 is transferred to the first output port P2, and about 50% of the power is transferred to the second output port P3. In FIG. 3D, a fourth power ratio of 2:1 between the first output port P2 and the second output port P3 can be achieved by adjusting the wiper within the wiper-type phase shifter PS to a fourth position (e.g., +9.5°), as shown, such that about 66% of the power associated with an RF feed signal received at the input port P1 is transferred to the first output port P2, and about 33% of the power is transferred to the second output port P3. In FIG. 3E, a fifth power ratio of 1:0 between the first output port P2 and the second output port P3 can be achieved by adjusting the wiper within the wiper-type phase shifter PS to a fifth position (e.g., +45°), as shown, such that essentially all of the power associated with an RF feed signal received at the input port P1 is transferred to the first output port P2. Finally, as will be understood by those skilled in the art, these first through fifth settings of the wiper position within the phase shifter PS can be treated as “digital” settings that support discrete and well-defined operating modes of a multi-sector antenna; nonetheless, intermediate “analog” settings of the wiper position may also be used in alternative applications of the multi-sector antenna to thereby achieve varying degrees of asymmetric activity within the antenna sectors.

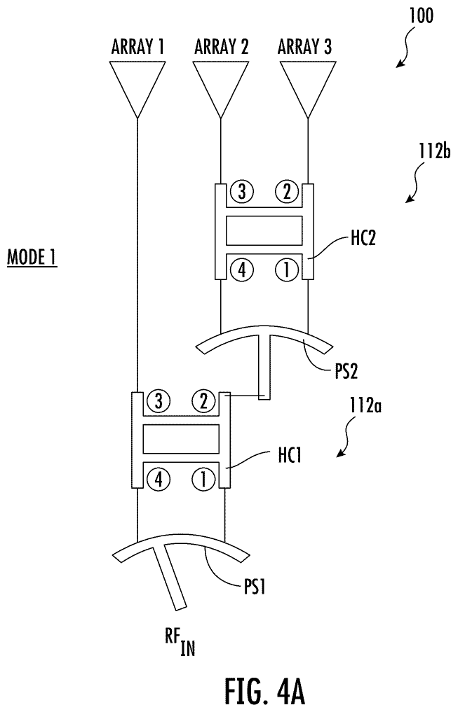

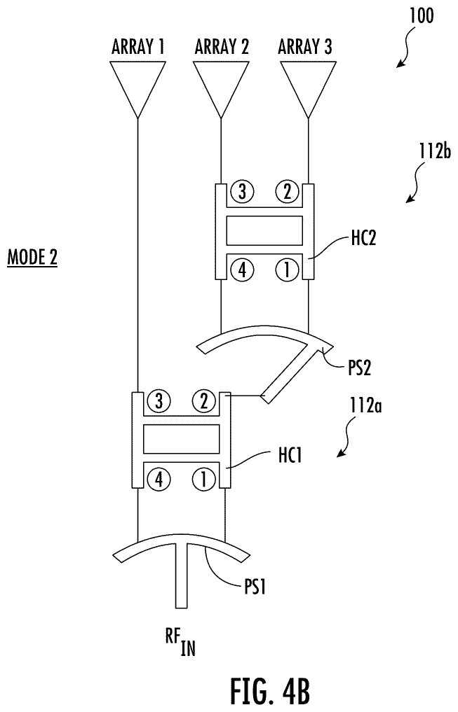

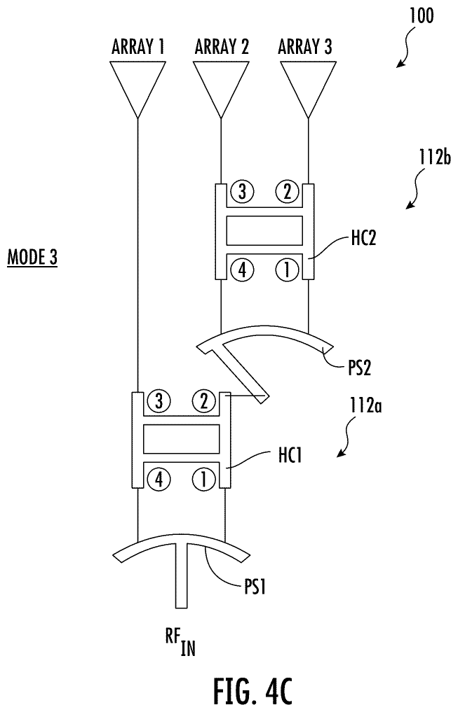

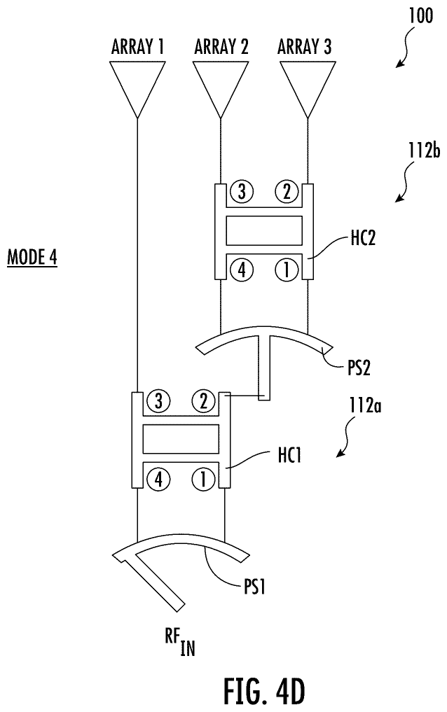

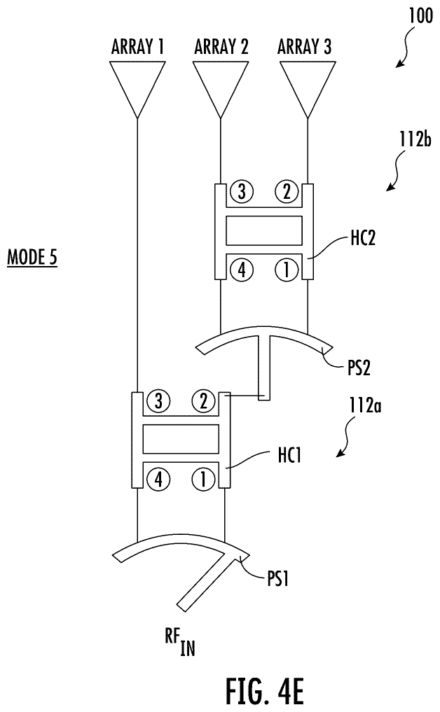

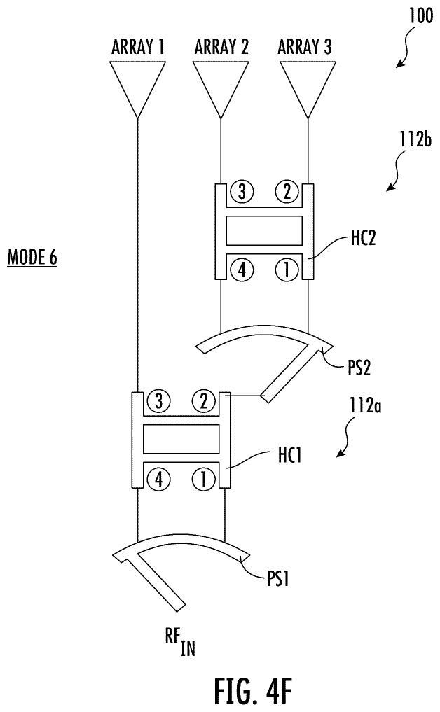

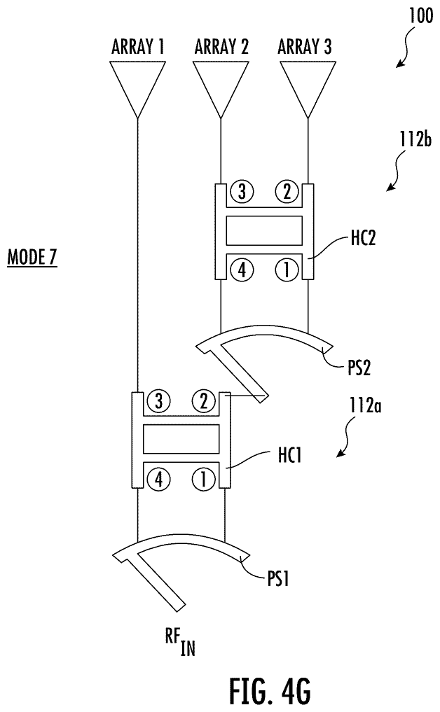

The seven discrete modes of operation of the 3-sector antenna 100 of FIG. 2A will now be described with reference to FIGS. 4A-4G. These seven modes include: Mode 1 with ARRAY1, ARRAY2 and ARRAY3 equally active (i.e., each array receives about ⅓^{rd} of the power from RF_{IN}), as shown by FIG. 4A, Mode 2 with ARRAY1 and ARRAY2 active, ARRAY3 inactive (i.e., the power of RF_{IN} is split about equally between ARRAY1 and ARRAY2), as shown by FIG. 4B, Mode 3 with ARRAY1 and ARRAY3 active, ARRAY2 inactive (i.e., the power of RF_{IN} is split about equally between ARRAY1 and ARRAY3), as shown by FIG. 4C, Mode 4 with ARRAY2 and ARRAY3 active, ARRAY1 inactive (i.e., the power of RF_{IN} is split about equally between ARRAY2 and ARRAY3), as shown by FIG. 4D, Mode 5 with ARRAY1 fully active, ARRAY2 and ARRAY3 inactive, as shown by FIG. 4E, Mode 6 with ARRAY2 fully active, ARRAY1 and ARRAY3 inactive, as shown by FIG. 4F, and Mode 7 with ARRAY3 fully active, ARRAY1 and ARRAY2 inactive, as shown by FIG. 4G.

Moreover, with respect to FIGS. 4A-4G and the five discrete power transfer configurations of FIGS. 3A-3E: Mode 1 can be achieved by setting the first phase shifter PS1 to the second power ratio and the second phase shifter PS2 to the third power ratio; Mode 2 can be achieved by setting the first phase shifter PS1 to the third power ratio and the second phase shifter PS2 to the fifth power ratio; Mode 3 can be achieved by setting the first phase shifter PS1 to the third power ratio and the second phase shifter PS2 to the first power ratio; Mode 4 can be achieved by setting the first phase shifter PS1 to the first power ratio and the second phase shifter PS2 to the third power ratio; Mode 5 can be achieved by setting the first phase shifter PS1 to the fifth power ratio and the second phase shifter PS2 to the third power ratio; Mode 6 can be achieved by setting the first phase shifter PS1 to the first power ratio and the second phase shifter PS2 to the fifth power ratio; and Mode 7 can be achieved by setting the first phase shifter PS1 to the first power ratio and the second phase shifter PS2 to the first power ratio. These configurations are summarized below by Table 1.

TABLE 1

| | Work State | 1^{st} Phase Shifter | 2^{nd} Phase Shifter | 1^{st} Phase Shifter | 2^{nd} Phase Shifter |
|---|---|---|---|---|---|
| Mode | (active) | Wiper Position | Wiper Position | Power Ratio | Power Ratio |
| 1 | ARRAY1-ARRAY3 | −9.5° | 0° | 1:2 | 1:1 |
| 2 | ARRAY1, ARRAY2 | 0° | +45° | 1:1 | 1:0 |
| 3 | ARRAY1, ARRAY3 | 0° | −45° | 1:1 | 0:1 |
| 4 | ARRAY2, ARRAY3 | −45° | 0° | 0:1 | 1:1 |
| 5 | ARRAY1 | +45° | 0° | 1:0 | 1:1 |
| 6 | ARRAY2 | −45° | +45° | 0:1 | 1:0 |
| 7 | ARRAY3 | −45° | −45° | 0:1 | 0:1 |

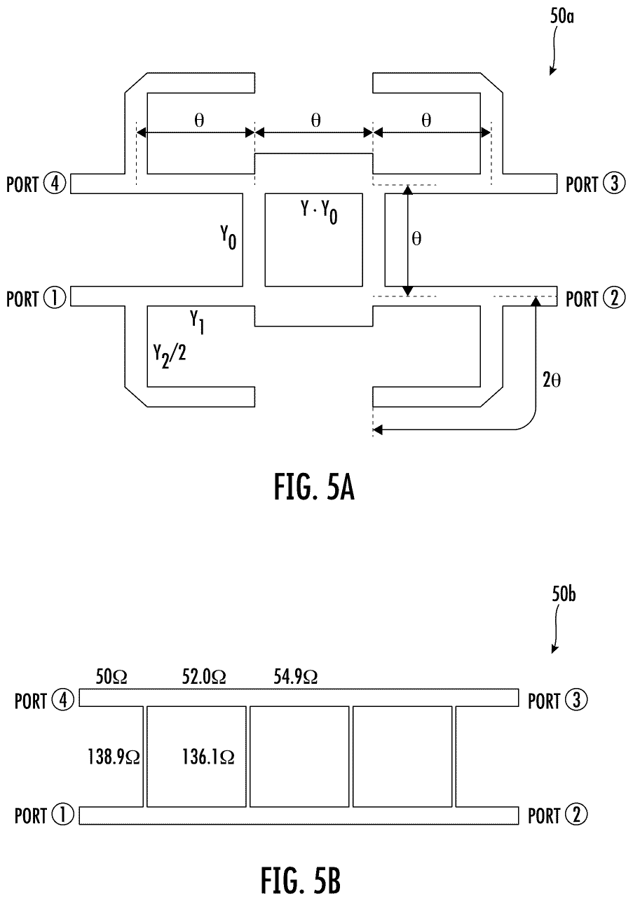

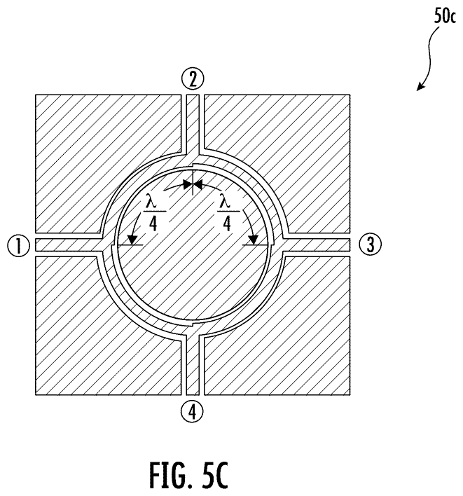

Although not wishing to be bound by any theory, the above-described antenna work states associated with Modes 1-7 generally assume ideal RF signal characteristics associated with each phase shifter and hybrid coupler in the cascaded arrangement. Nonetheless, because of potential bandwidth limitations associated with conventional hybrid couplers, insufficient inhibition of RF signals at one or more output ports of the couplers HC1, HC2 may result in some limited degree of RF power being provided to an array(s) having an inactive work state, which may adversely impact a front-to-back (F/B) ratio of the multi-sector antenna described herein. Fortunately, as illustrated by FIGS. 5A-5C, hybrid couplers having wider bandwidths may be utilized within the above-described feed networks. These hybrid couplers include a parallel λ/2 open branch coupler 50a, as shown by FIG. 5A, a multi-segment hybrid coupler 50b, as shown by FIG. 5B, and a coplanar waveguide (CPW) circle hybrid coupler 50c, as shown by FIG. 5C.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A multi-mode antenna, comprising:
a feed network comprising a cascaded arrangement of a first phase shifter and hybrid coupler pair, which is responsive to a radio frequency (RF) input feed signal, and a second phase shifter and hybrid coupler pair, which is responsive to an RF feed signal generated at a second output port of the first phase shifter and hybrid coupler pair;
a first array (ARRAY1) responsive to a RF feed signal derived from a first output port of the first phase shifter and hybrid coupler pair;
a second array (ARRAY2) responsive to an RF feed signal derived from a first output port of the second phase shifter and hybrid coupler pair; and
a third array (ARRAY3) responsive to an RF feed signal derived from a second output port of the second phase shifter and hybrid coupler pair.

2. The antenna of claim 1,
wherein said feed network further comprises a third phase shifter and hybrid coupler pair, which is responsive to an RF feed signal generated at the first output port of the first phase shifter and hybrid coupler pair; and
wherein the first array is responsive to an RF feed signal derived from a first output port of the third phase shifter and hybrid coupler pair.

3. The antenna of claim 2, further comprising a fourth array responsive to an RF feed signal derived from a second output port of the third phase shifter and hybrid coupler pair.

4. The antenna of claim 1, wherein the first, second and third arrays are configured to radiate in respective first, second and third sectors of a three-sector antenna; and wherein the feed network is configured such that the first array is responsive to an RF signal that bypasses the second phase shifter and hybrid coupler pair, whereas the second and third arrays are responsive to RF signals that pass through both the first phase shifter and hybrid coupler pair and the second phase shifter and hybrid coupler pair.

5. The antenna of claim 4, wherein said feed network is configured to support, through adjustments to the first and second phase shifters, each of the following seven operating modes: (i) ARRAY1, ARRAY2 and ARRAY3 active, (ii) ARRAY1 and ARRAY2 active, ARRAY3 inactive (iii) ARRAY1 and ARRAY3 active, ARRAY2 inactive (iv) ARRAY2 and ARRAY3 active, ARRAY1 inactive, (v) ARRAY1 active, ARRAY2 and ARRAY3 inactive, (vi) ARRAY2 active, ARRAY1 and ARRAY3 inactive, and (vii) ARRAY3 active, ARRAY1 and ARRAY2 inactive.

6. The antenna of claim 5, wherein said feed network is further configured to support, through adjustments to the first and second phase shifters, a plurality of operating modes intermediate the seven operating modes.

7. The antenna of claim 1, wherein at least one of the first and second hybrid couplers is selected from a group consisting of parallel λ/2 open branch couplers, multi-segment hybrid couplers, and coplanar waveguide (CPW) circle hybrid couplers.

8. A multi-mode antenna, comprising:
first, second and third arrays (ARRAY1, ARRAY2 and ARRAY3) responsive to first, second and third RF feed signals, respectively; and
a feed network configured to generate the first, second and third RF feed signals in response to a radio frequency (RF) input feed signal, and support, through adjustments therein, each of the following seven operating modes: (i) ARRAY1, ARRAY2 and ARRAY3 active, (ii) ARRAY1 and ARRAY2 active, ARRAY3 inactive (iii) ARRAY1 and ARRAY3 active, ARRAY2 inactive (iv) ARRAY2 and ARRAY3 active, ARRAY1 inactive, (v) ARRAY1 active, ARRAY2 and ARRAY3 inactive, (vi) ARRAY2 active, ARRAY1 and ARRAY3 inactive, and (vii) ARRAY3 active, ARRAY1 and ARRAY2 inactive.

9. The antenna of claim 8, wherein said feed network is further configured to support, through adjustments therein, a plurality of modes intermediate the seven operating modes.

10. The antenna of claim 9, wherein said feed network comprises a plurality of phase shifters therein; and wherein each of the seven operating modes is established by a unique setting of the plurality of phase shifters.

11. The antenna of claim 10, wherein each of the plurality of phase shifters is paired with a corresponding coupler within the feed network.

12. In a multi-sector antenna having at least first, second and third arrays of radiating elements (ARRAY1, ARRAY2 and ARRAY3) therein, a method of operating the multi-sector antenna to support multiple modes, comprising:
adjusting at least one phase shifter within a cascaded arrangement of a first phase shifter and hybrid coupler pair having an input port configured to receive a radio frequency (RF) input feed signal, and a second phase shifter and hybrid coupler pair having an input port responsive to a RF feed signal generated at a second output port of the first phase shifter and hybrid coupler pair, to thereby switch the multi-sector antenna between at least two of the following seven operating modes: (i) ARRAY1, ARRAY2 and ARRAY3 active, (ii) ARRAY1 and ARRAY2 active, ARRAY3 inactive (iii) ARRAY1 and ARRAY3 active, ARRAY2 inactive (iv) ARRAY2 and ARRAY3 active, ARRAY1 inactive, (v) ARRAY1 active, ARRAY2 and ARRAY3 inactive, (vi) ARRAY2 active, ARRAY1 and ARRAY3 inactive, and (vii) ARRAY3 active, ARRAY1 and ARRAY2 inactive.

13. The method of claim 12, wherein the first array (ARRAY1) is responsive to a RF feed signal derived from a first output port of the first phase shifter and hybrid coupler pair; wherein the second array (ARRAY2) is responsive to an RF feed signal derived from a first output port of the second phase shifter and hybrid coupler pair; and wherein the third array (ARRAY3) is responsive to an RF feed signal derived from a second output port of the second phase shifter and hybrid coupler pair.

14. The method of claim 12, wherein said adjusting comprises:
adjusting at least one phase shifter within the cascaded arrangement to thereby switch the multi-sector antenna into an operating mode that is intermediate at least two of the seven operating modes.
